(19) United States
(12) Patent Application Publication
(10) Pub. No.: US 2026/0321046 A1
(43) Pub. Date: Oct. 15, 2026

(54) IMAGE PROCESSING METHOD AND APPARATUS, DEVICE, AND STORAGE MEDIUM

(71) Applicant: CHINA UNIONPAY CO., LTD., Shanghai (CN)

(72) Inventors: Zhijun FEI, Shanghai (CN); Xuetao QIU, Shanghai (CN); Yanming YANG, Shanghai (CN); Xufeng LV, Shanghai (CN); Pengfei GAO, Shanghai (CN); Wenji XING, Shanghai (CN)

(21) Appl. No.: 19/482,569

(22) PCT Filed: Apr. 9, 2024
(86) PCT No.: PCT/CN2024/086859

§ 371 Date: Nov. 7, 2025

(30) Foreign Application Priority Data
May 8, 2023 (CN) 202310512786.4

(51) Int. Cl. G06V 20/00; G06T 7/50; G06V 10/77; G06V 10/774; G06V 10/776; G06V 40/40

(52) U.S. Cl. CPC G06V 20/95; G06T 7/50; G06V 10/7715; G06V 10/774; G06V 10/776; G06V 40/40; G06T 2207/20081; G06T 2207/30201

(57) ABSTRACT

The embodiments of the present disclosure provide an image processing method and apparatus, device, and storage medium, which relate to the field of artificial intelligence technology. The method includes: obtaining a to-be-processed image; predicting respective depth estimation values of a plurality of pixel points in the to-be-processed image through a depth estimation model; predicting corresponding clarity estimation values based on an obtained plurality of depth estimation values through a clarity model; determining forged points among the plurality of pixel points based on an obtained plurality of clarity estimation values and respective actual clarity values of the plurality of pixel points; and if a quantity of the forged points is greater than a first threshold, determining the to-be-processed image to be a forged image. First, predict the depth estimation value of each pixel point in the to-be-processed image, and then predict the clarity estimation value of each pixel point based on a correlation between depth values and the clarity values in real images. By comparing the clarity estimation value with the actual clarity value, determine whether the to-be-processed image is a forged image, thereby improving the accuracy and efficiency of distinguishing forged images.

### CROSS-REFERENCE TO RELATED APPLICATIONS

This application claims priority to the Chinese patent application filed with the State Intellectual Property Office of China on May 8, 2023, with application No. 202310512786.4 and application title “IMAGING PROCESSING METHOD AND APPARATUS, DEVICE, AND STORAGE MEDIUM”, the entire content of which is incorporated by reference into this application.

### FIELD OF THE DISCLOSURE

The present disclosure generally relates to the field of artificial intelligence technology, and in particular to an image processing method and apparatus, device, and storage medium.

### BACKGROUND

With the development of internet technology, various applications have emerged one after another. To enhance user experience, some video applications use facial manipulation technology to forge facial images to achieve animated facial effects. For example, these applications use facial manipulation technology to forge facial images related to blinking and opening the mouth to achieve these effects.

In real life, in order to ensure financial security, financial applications generally require facial recognition verification, and during facial recognition verification, they need to cooperate with actions such as blinking and opening their mouths to reduce the risk of being hacked.

However, facial images forged based on facial manipulation technology may evade facial recognition verification in financial applications, enabling attacks on facial recognition systems and thus posing security issues for facial recognition systems. Therefore, how to identify forged images is a technical problem that needs to be currently addressed.

### SUMMARY

The embodiments of the present disclosure provide an image processing method and apparatus, device, and storage medium for identifying forged images, thereby improving the security of a face recognition system.

In one aspect, an embodiment of the present disclosure provides an image processing method, and the method includes: obtaining a to-be-processed image; predicting respective depth estimation values of a plurality of pixel points in the to-be-processed image using a depth estimation model; predicting corresponding clarity estimation values, based on an obtained plurality of depth estimation values, using a clarity model; determining forged points among the plurality of pixel points based on an obtained plurality of clarity estimation values and respective actual clarity values of the plurality of pixel points; and if a quantity of the forged points is greater than a first threshold, determining the to-be-processed image to be a forged image.

In the disclosed embodiment, the depth estimation value of each pixel point in the to-be-processed image is first predicted. Then, based on the correlation between depth and clarity values in real images, the clarity estimation value of each pixel point is predicted based on the depth estimation value of each pixel point. By comparing the clarity estimation value with the actual clarity value, it is determined whether the to-be-processed image is a forged image, thereby improving the accuracy and efficiency of identifying forged images.

Optionally, the determining of forged points among the plurality of pixel points based on the obtained plurality of clarity estimation values and the actual clarity values of the plurality of pixel points includes: for the plurality of pixel points, perform the following steps respectively: if a difference between a clarity estimation value of a pixel point and an actual clarity value of the pixel point is greater than a second threshold, determining the pixel point to be a forged point.

In an embodiment of the present disclosure, since there is a specific correlation between the depth value and the clarity value of a pixel point in a real image, after the clarity estimation value of a pixel point is obtained based on the correlation and the depth estimation value of the pixel point, it is possible to determine whether the pixel point in the to-be-processed image is a forged point based on the difference between the clarity estimation value of the pixel point and the actual clarity value, so as to subsequently determine whether the to-be-processed image is a forged image.

Optionally, the method also includes: for the plurality of pixel points, performing the following steps respectively: determining multiple neighboring pixel points of a pixel point, as well as a grayscale difference and a distance value between the pixel point and each neighboring pixel point, and determining a grayscale change rate between the pixel point and each neighboring pixel point based on the obtained grayscale difference and distance value; and summing obtained multiple grayscale change rates to obtain the actual clarity value of the pixel point.

In an embodiment of the present disclosure, the actual clarity value of a pixel point is obtained by calculating the grayscale changes between the pixel point and multiple neighboring pixel points and summing the multiple grayscale changes, so that the actual clarity value of the pixel point is more accurate.

Optionally, the clarity model includes a first convolution layer, a nonlinear mapping layer and a second convolution layer; and the method of predicting the corresponding clarity estimation values based on the obtained plurality of depth estimation values through the clarity model includes: for each depth estimation value, performing a convolution processing on the depth estimation value through the first convolution layer to obtain intermediate features; mapping the intermediate features through the nonlinear mapping layer to determine a feature mapping result; and performing a convolution processing on the feature mapping result by the second convolutional layer to obtain a corresponding clarity estimation value.

Optionally, the depth estimation model and the clarity model are obtained by joint training.

In an embodiment of the present disclosure, the depth estimation model and the clarity model are jointly trained instead of being trained separately, so that the training results are based on the depth value and the clarity value, thereby obtaining the correlation between depth values and clarity values.

Optionally, the depth estimation model and the clarity model are obtained by joint training, including: obtaining a plurality of sample images, each sample image corresponding to a depth label and a clarity label; jointly iteratively training a to-be-trained depth estimation model and a to-be-trained clarity model using the plurality of sample images until an iteration stop condition is satisfied, and outputting a trained depth estimation model and a trained clarity model, where each iteration process includes the following steps: determining a depth estimation result of a sample image using the to-be-trained depth estimation model; determining a clarity estimation result of the sample image based on the depth estimation result using the to-be-trained clarity model; based on the depth estimation result, the clarity estimation result, the depth label and the clarity label, determining a target loss value, where the target loss value is used to adjust parameters of the to-be-trained depth estimation model and the to-be-trained clarity model.

In an embodiment of the present disclosure, when training the depth estimation model and the clarity model, the model training effect may be made more accurate through continuous iteration.

Optionally, determining a target loss value based on the depth estimation result, the clarity estimation result, the depth label, and the clarity label includes: determining a first mean square error based on the depth estimation result and the depth label; determining a second mean square error based on the clarity estimation result and the clarity label; and summing the first mean square error and the second mean square error to obtain the target loss value.

In an embodiment of the present disclosure, the mean square errors of the two dimensions of joint clarity estimation and depth estimation are used as the loss function for model training to jointly train the depth estimation model and the clarity model, so that the depth estimation model and the clarity model influence each other during the training process, thereby improving the effect of model training.

In one aspect, an embodiment of the present disclosure provides an image processing apparatus, including: an acquisition module, configured to obtain a to-be-processed image; a depth prediction module, configured to predict respective depth estimation values of a plurality of pixel points in the to-be-processed image by using a depth estimation model; a clarity prediction module, configured to predict corresponding clarity estimation values, based on an obtained plurality of depth estimation values, using a clarity model; a determination module, configured to determine forged points among the plurality of pixel points based on an obtained plurality of clarity estimation values and respective actual clarity values of the plurality of pixel points; and an assessment module, configured to determine the to-be-processed image to be a forged image if a quantity of the forged points is greater than a first threshold.

Optionally, the determination module is specifically configured to: for the plurality of pixel points, perform the following steps respectively: if a difference between a clarity estimation value of a pixel point and an actual clarity value of a pixel point is greater than a second threshold, determining the pixel point to be a forged point.

Optionally, the determination module is further configured to: for the plurality of pixel points, perform the following steps respectively: determining multiple neighboring pixel points of a pixel point, as well as a grayscale difference and a distance value between the pixel point and each of the neighboring pixel points, and determining a grayscale change rate between the pixel point and each of the neighboring pixel points based on the obtained grayscale difference and distance value; and summing obtained multiple grayscale change rates to obtain the actual clarity value of the pixel point.

Optionally, the determination module is specifically configured to: for each depth estimation value, perform a convolution processing on the depth estimation value through a first convolution layer to obtain intermediate features; map the intermediate features through a nonlinear mapping layer to determine a feature mapping result; and perform a convolution processing on the feature mapping result by a second convolutional layer to obtain a corresponding clarity estimation value.

Optionally, the depth estimation model and the clarity model are obtained by joint training.

Optionally, the determination module is specifically configured to: obtain a plurality of sample images, each sample image corresponding to a depth label and a clarity label; jointly iteratively train a to-be-trained depth estimation model and a to-be-trained clarity model using the plurality of sample images until an iteration stop condition is satisfied, and output a trained depth estimation model and a trained clarity model, where each iteration process includes the following steps: determining a depth estimation result of a sample image using a to-be-trained depth estimation model; determining a clarity estimation result of the sample image based on the depth estimation result using a to-be-trained clarity model; and based on the depth estimation result, the clarity estimation result, the depth label and the clarity label, determining a target loss value, where the target loss value is used to adjust parameters of the to-be-trained depth estimation model and the to-be-trained clarity model.

Optionally, the determination module is specifically configured to: determine a first mean square error based on the depth estimation result and the depth label; determine a second mean square error based on the clarity estimation result and the clarity label; and sum the first mean square error and the second mean square error to obtain the target loss value.

In one aspect, an embodiment of the present disclosure provides a computer device, including a memory, a processor, and a computer program stored in the memory and executable on the processor, where the processor implements the steps of the above-described image processing methods when executing the program.

In one aspect, an embodiment of the present disclosure provides a computer-readable storage medium, which stores a computer program that may be executed by a computer device. When the program is run on the computer device, the computer device executes the steps of the above-described image processing methods.

### BRIEF DESCRIPTION OF THE DRAWINGS

FIG. 1 is a system architecture diagram in accordance with an embodiment of the present disclosure;

FIG. 2 is a flowchart of an image processing method in accordance with an embodiment of the present disclosure;

FIG. 3 is a flowchart of determining a clarity estimation value in accordance with an embodiment of the present disclosure;

FIG. 4 is a schematic structural diagram of a clarity model in accordance with an embodiment of the present disclosure;

FIG. 5 is a schematic diagram of a framework for joint training a depth estimation model and a clarity model in accordance with an embodiment of the present disclosure;

FIG. 6 is a flowchart of determining a target loss value in accordance with an embodiment of the present disclosure;

FIG. 7 is a flowchart of a second image processing method in accordance with an embodiment of the present disclosure;

FIG. 8 is a schematic structural diagram of an image processing apparatus in accordance with an embodiment of the present disclosure; and

FIG. 9 is a computer device in accordance with an embodiment of the present disclosure.

### DETAILED DESCRIPTION

In order to make the purpose, technical solutions and beneficial effects of the present disclosure more clearly understood, the present disclosure will be further described in detail hereinafter with reference to the accompanying drawings and embodiments. It should be understood that the specific embodiments described herein are merely used to explain the present disclosure and are not intended to limit the present disclosure.

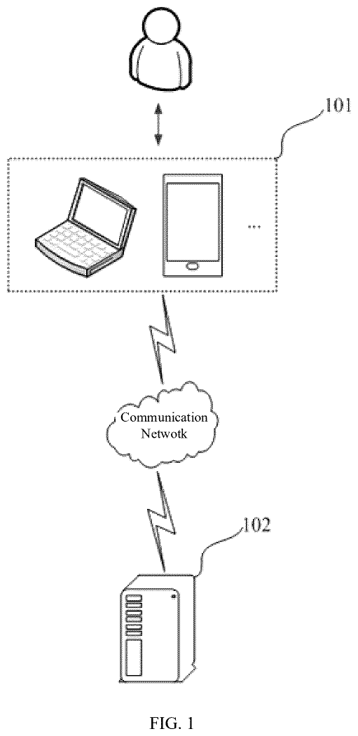

As shown in FIG. 1, which is a system architecture diagram of an image processing method in accordance with an embodiment of the present disclosure, and the system architecture diagram includes a terminal device 101 and a server 102.

Here, the terminal device 101 is pre-installed with a service application for identifying forged images. This service application may be a mini-program application or a client application. The server 102 is a backend server for the service application. The server 102 may be a standalone physical server, a server cluster or distributed system consisting of a plurality of physical servers, or a cloud server that provides basic cloud computing services such as cloud services, cloud databases, cloud computing, cloud functions, cloud storage, network services, cloud communications, middleware services, domain name services, security services, content delivery networks (CDNs), and big data and artificial intelligence platforms.

The image processing methods in the embodiments of the present disclosure may be executed by the terminal device 101, may be executed by the server 102, or may be executed interactively by the terminal device 101 and the server 102.

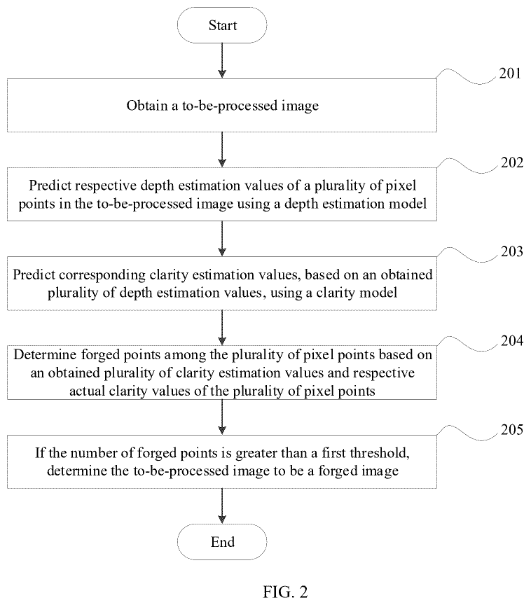

Based on the system architecture diagram of FIG. 1, an embodiment of the present disclosure provides an image processing method, as shown in FIG. 2. The method is performed by a computer device, which may be the terminal device 101 and/or the server 102 shown in FIG. 1, and includes the following steps.

Step 201: Obtain a to-be-processed image.

Specifically, the to-be-processed image may be an image that needs a forgery evaluation, such as a bank card image, a membership card image, or a face image.

Step 202: Predict respective depth estimation values of a plurality of pixel points in the to-be-processed image using a depth estimation model.

Specifically, pixel depth refers to the number of bits used to store each pixel and is also used to measure image resolution. A deeper pixel depth occupies more storage space; conversely, a shallow pixel depth may affect image quality. A trained depth estimation model may be used to predict depth estimation values for a plurality of pixel points in the to-be-processed image. The plurality of pixel points may be all or a subset of the pixels in the to-be-processed image.

Step 203: Predict corresponding clarity estimation values, based on an obtained plurality of depth estimation values, using a clarity model.

Specifically, in a real image captured by a camera, there is a correlation between the depth value and the clarity value of a pixel point. Therefore, the above correlation is learned by training the clarity model. After the training is completed, the depth estimation values of the plurality of pixel points in the to-be-processed image are input into the trained clarity model for prediction to obtain the respective clarity estimation values of the plurality of pixel points.

Step 204: Determine forged points among the plurality of pixel points based on an obtained plurality of clarity estimation values and respective actual clarity values of the plurality of pixel points.

Specifically, for each pixel point among the plurality of pixel points, the clarity estimation value of the pixel point is compared with the actual clarity value of the pixel point to determine whether the pixel point is a forged point.

In some embodiments, for the plurality of pixel points, the following steps are performed respectively.

If the difference between the clarity estimation value of a pixel point and the actual clarity value of the pixel point is greater than a second threshold, the pixel point is determined to be a forged point.

Specifically, a determination is made as to whether the difference between the clarity estimation value and the actual clarity value of each pixel point in the to-be-processed image is greater than a second threshold. If so, the pixel point is considered a forged point; otherwise, the pixel point is not a forged point. The second threshold may be set according to specific requirements.

For example, the second threshold is set to 10. If the difference between the clarity estimation value and the actual clarity value of a pixel point in the to-be-processed image is 5, that is, the difference between the clarity estimation value and the actual clarity value of the pixel point is less than the second threshold, then the pixel point is not a forged point. If the difference between the clarity estimation value and the actual clarity value of a pixel point is 20, that is, the difference between the clarity estimation value and the actual clarity value of the pixel point is greater than the second threshold, then the pixel point is a forged point.

In some embodiments, for the plurality of pixel points, the following steps are performed respectively: determining multiple neighboring pixel points of a pixel point, as well as a grayscale difference and a distance value between the pixel point and each neighboring pixel point, and based on the obtained grayscale difference and distance value, determining a grayscale change rate between a pixel point and each neighboring pixel point; and summing obtained multiple grayscale change rates to obtain the actual clarity value of the pixel point.

Specifically, the embodiments of the present disclosure determine the actual clarity value of each pixel point of the to-be-processed image by a point sharpness algorithm. For each pixel point among the plurality of pixel points of the to-be-processed image, first determine eight neighboring pixel points adjacent to the pixel point. For each neighboring pixel point, determine the grayscale difference and distance value between the pixel point and the neighboring pixel point. The ratio of the grayscale difference to the distance value is used as the grayscale change rate between the pixel point and the neighboring pixel point. Then, the obtained eight grayscale change rates are summed to obtain the actual clarity value of the pixel point, as shown in formula (1):

$$P = {\sum }_{a = 1}^{8} \vert df / dx \vert \qquad ( 1 )$$

Here, df is the grayscale difference between a pixel point and its neighboring pixel point, dx is the distance value between the pixel point and its neighboring pixel point (the eight neighboring pixel points include four neighboring pixel points located on the diagonals of the pixel point, and the distance between these four neighboring pixel points and the pixel point is \sqrt{2}, and the distance between other neighboring pixel points and the pixel point is 1), and P is the actual clarity value of the pixel point.

Step 205: If the number of forged points is greater than a first threshold, determine the to-be-processed image to be a forged image.

Specifically, if the number of forged points is greater than a first preset threshold, the to-be-processed image is considered a forged image. For example, the first preset threshold is set to 1, that is, as long as there is one forged pixel in the to-be-processed image, the to-be-processed image is considered a forged image.

In the embodiments of the present disclosure, the depth estimation value of each pixel point in the to-be-processed image is first predicted. Then, based on the correlation between depth estimation values and clarity estimation values in real images, the clarity estimation value of each pixel point is predicted based on the depth estimation value of each pixel point. By comparing the clarity estimation value with the actual clarity value, it is determined whether the to-be-processed image is a forged image, thereby improving the accuracy and efficiency of identifying forged images.

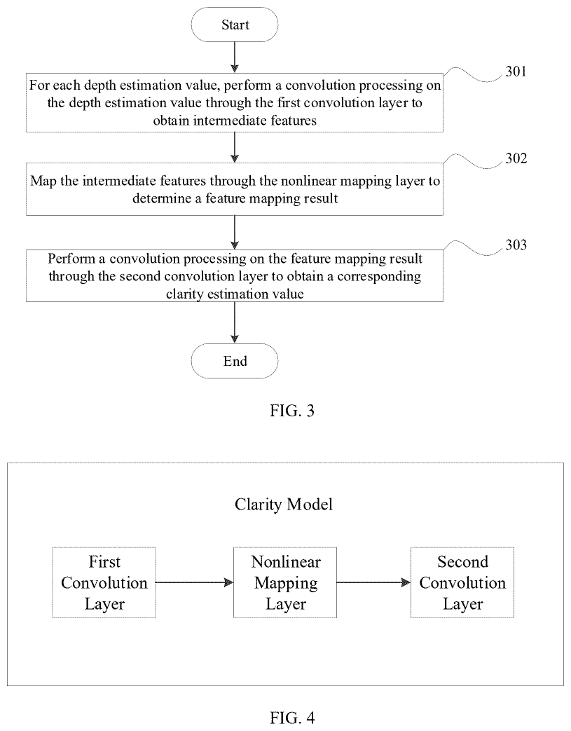

In some embodiments, the clarity model includes a first convolution layer, a nonlinear mapping layer, and a second convolution layer. The process of predicting the clarity estimation value using the clarity model, as shown in FIG. 3, includes the following steps.

Step 301: For each depth estimation value, perform a convolution processing on the depth estimation value through the first convolution layer to obtain intermediate features.

Specifically, as shown in FIG. 4 (which it the structure of the clarity model), the clarity model includes a first convolutional layer, a nonlinear mapping layer, and a second convolutional layer. After the depth estimation model obtains a depth estimation value for the to-be-processed image, the depth estimation model inputs the depth estimation value into the clarity model. This depth estimation value is then convolved in the first convolutional layer to obtain intermediate features.

Step 302: Map the intermediate features through the nonlinear mapping layer to determine a feature mapping result.

Step 303: Perform a convolution processing on the feature mapping result through the second convolution layer to obtain a corresponding clarity estimation value.

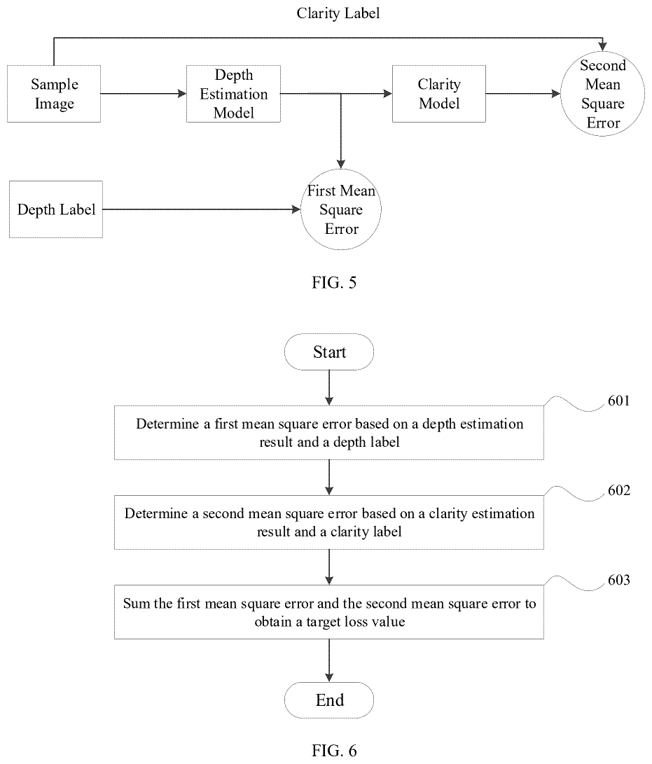

In some embodiments, the depth estimation model and the clarity model are jointly trained. The framework for the joint training of the depth estimation model and the clarity model is shown in FIG. 5. The process of jointly training the depth estimation model and the clarity model based on the framework shown in FIG. 5 includes the following steps.

Step 501: Acquire a plurality of sample images, each sample image corresponding to a depth label and a clarity label.

Specifically, the depth label corresponding to the sample image includes actual depth values of a plurality of sample pixel points in the sample image, and the clarity label corresponding to the sample image includes actual clarity values of the plurality of sample pixels in the sample image.

Step 502: Perform a joint iterative training on a to-be-trained depth estimation model and a to-be-trained clarity model using the plurality of sample images until an iteration stop condition is satisfied, and output a trained depth estimation model and a trained clarity model.

Specifically, each iteration process includes: the to-be-trained depth estimation model is used to determine a depth estimation result of the sample image. The to-be-trained clarity model is used to determine a clarity estimation result of the sample image based on the depth estimation result. Based on the depth estimation result, the clarity estimation result, the depth label, and the clarity label, a target loss value is determined and used to adjust the parameters of the to-be-trained depth estimation model and the to-be-trained clarity model.

Specifically, a sample image is input into the to-be-trained depth estimation model to obtain a depth estimation result for the sample image, which includes the predicted depth values of the plurality of sample pixel points. The depth estimation result is input into the to-be-trained clarity model to obtain a clarity estimation result for the sample image, which includes the predicted clarity values of the plurality of sample pixel points.

The depth estimation result, clarity estimation result, depth label, and clarity label are input into the loss function to obtain the target loss value, and the target loss value is used to adjust the parameters of the to-be-trained depth estimation model and the to-be-trained clarity model.

In practical applications, the iteration stopping condition may be the convergence of the target loss value or the number of iterations reaching a preset number.

In some embodiments, a process of determining the target loss value based on the depth estimation result, the clarity estimation result, the depth label, and the clarity label is shown in FIG. 6, and includes the following steps.

Step 601: Determine a first mean square error based on a depth estimation result and a depth label.

Specifically, the mean square error is a measure of the degree of difference between the estimating values and the estimated values. The first mean square error is determined based on the depth estimation result and the depth label of the sample image. The specific calculation of the first mean square error is shown in formula (2):

$$L ( θ ) = \frac{1}{n} {\sum }_{i = 1}^{n} {‖ F ( {Y}_{i} ; θ ) - {X}_{i} ‖}^{2} \qquad ( 2 )$$

Here, F(Yᵢ;θ) is the function corresponding to the depth estimation model, θ is the coefficient of the depth estimation model, Yᵢ is the depth estimation value of the sample pixel point i, Xᵢ is the actual depth value of the sample pixel point i, L(θ) is the first mean square error, and n is the number of sample pixels.

Step 602: Determine a second mean square error based on a clarity estimation result and a clarity label.

The method for calculating the second mean square error is the same as the method for calculating the first mean square error, and will not be repeated here.

Step 603: Sum the first mean square error and the second mean square error to obtain the target loss value.

Specifically, the first mean square error and the second mean square error are summed to obtain the target loss value. The target loss value is calculated as shown in formula (3):

Loss=MSE(DI,D)+MSE(RP,P) (3)

Here, DI is the depth estimation result, D is the depth label, RP is the clarity estimation result, P is the clarity label, and Loss is the target loss value.

In the embodiments of the present disclosure, the mean square errors of the two dimensions of joint clarity estimation and depth estimation are used as the loss function for model training to jointly train the depth estimation model and the clarity model, so that the depth estimation model and the clarity model influence each other during the training process, thereby improving the effect of model training.

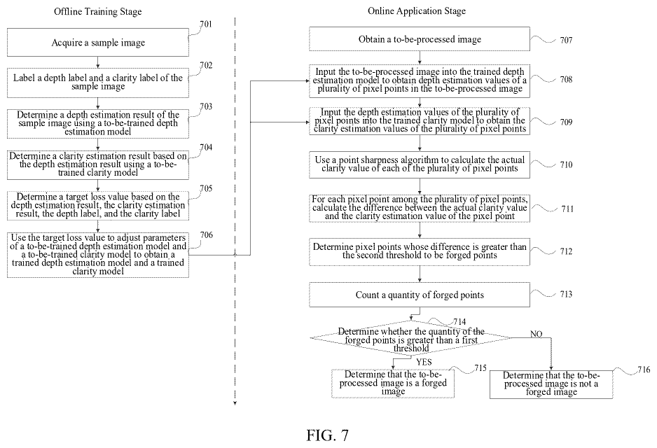

In order to better explain the embodiments of the present disclosure, an image processing method provided by the embodiments of the present disclosure is described hereinafter in connection with a specific implementation scenario, including an offline training stage and an online application stage, as shown in FIG. 7.

First, the offline training stage is described, which includes the following steps.

Step 701: Acquire a sample image.

Step 702: Label a depth label and a clarity label of the sample image.

Step 703: Determine a depth estimation result of the sample image using a to-be-trained depth estimation model.

Step 704: Determine a clarity estimation result based on the depth estimation result using a to-be-trained clarity model.

Step 705: Determine a target loss value based on the depth estimation result, the clarity estimation result, the depth label, and the clarity label.

Step 706: Use the target loss value to adjust parameters of a to-be-trained depth estimation model and a to-be-trained clarity model to obtain a trained depth estimation model and a trained clarity model.

Next, the online application stage is described, which includes the following steps.

Step 707: Obtain a to-be-processed image.

Step 708: Input the to-be-processed image into the trained depth estimation model to obtain depth estimation values of a plurality of pixel points in the to-be-processed image.

Step 709: Input the depth estimation values of the plurality of pixel points into the trained clarity model to obtain the clarity estimation values of the plurality of pixel points.

Step 710: Use a point sharpness algorithm to calculate the actual clarity value of each of the plurality of pixel points.

Step 711: For each pixel point among the plurality of pixel points, calculate the difference between the actual clarity value and the clarity estimation value of the pixel point.

Step 712: Determine pixel points whose difference is greater than the second threshold to be forged points.

Step 713: Count a quantity of forged points.

Step 714: Determine whether the quantity of the forged points is greater than a first threshold. If so, execute step 715; otherwise, execute step 716.

Step 715: Determine that the to-be-processed image is a forged image.

Step 716: Determine that the to-be-processed image is not a forged image.

In the embodiments of the present disclosure, the depth estimation value of each pixel point in the to-be-processed image is first predicted. Then, based on the correlation between depth values and clarity values in real images, the clarity estimation value of each pixel point is predicted based on the depth estimation value of each pixel point. By comparing the clarity estimation value with the actual clarity value, it is determined whether the to-be-processed image is a forged image, thereby improving the accuracy and efficiency of identifying forged images.

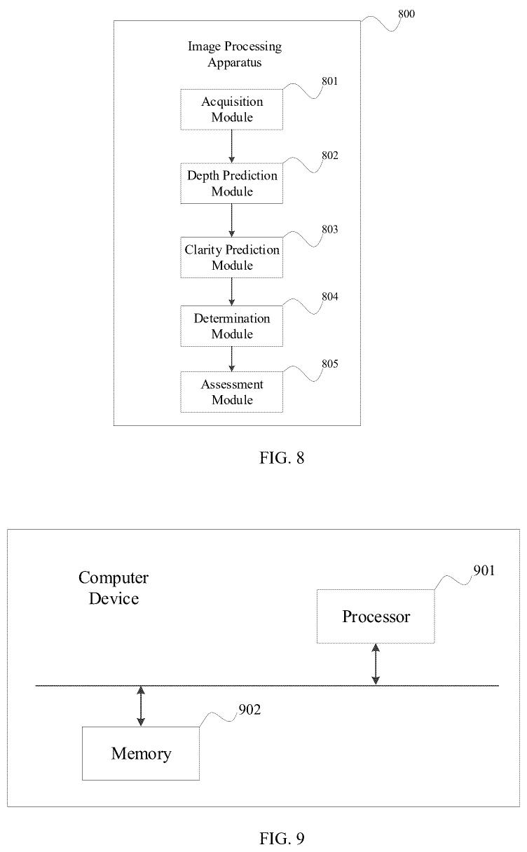

Based on the similar technical concept, an embodiment of the present disclosure provides an image processing apparatus 800, as shown in FIG. 8, which includes:

An acquisition module 801, configured to acquire a to-be-processed image.

A depth prediction module 802, configured to predict respective depth estimation values of a plurality of pixel points in the to-be-processed image using a depth estimation model.

A clarity prediction module 803, configured to predict corresponding clarity estimation values, based on an obtained plurality of depth estimation values, using a clarity model.

A determination module 804, configured to determine forged points among the plurality of pixel points based on the obtained plurality of clarity estimation values and actual clarity values of the plurality of pixel points.

An assessment module 805 is configured to determine that the to-be-processed image is a forged image if the number of forged points is greater than a first threshold.

Optionally, the determination module 804 is specifically configured to: for the plurality of pixel points, perform the following steps respectively: if the difference between the clarity estimation value of a pixel point and the actual clarity value of the pixel point is greater than a second threshold, the pixel point is determined to be a forged point.

Optionally, the determination module 804 is further configured to: for the plurality of pixel points, perform the following steps respectively: determining multiple neighboring pixel points of a pixel point, as well as a grayscale difference and a distance value between the pixel point and each of the neighboring pixel points, and determining a grayscale change rate between the pixel point and each of the neighboring pixel points based on the obtained grayscale difference and distance value, and summing obtained multiple grayscale change rates to obtain the actual clarity value of the pixel point.

Optionally, the determination module 804 is specifically configured to: for each depth estimation value, perform a convolution processing on the depth estimation value through a first convolution layer to obtain intermediate features, map the intermediate features through a nonlinear mapping layer to determine a feature mapping result, and perform a convolution processing on the feature mapping result by a second convolutional layer to obtain a corresponding clarity estimation value.

Optionally, the depth estimation model and the clarity model are obtained through joint training.

Optionally, the determination module 804 is specifically configured to: obtain a plurality of sample images, each sample image corresponding to a depth label and a clarity label, jointly iteratively training a to-be-trained depth estimation model and a to-be-trained clarity model using the plurality of sample images until an iteration stop condition is satisfied, and output a trained depth estimation model and a trained clarity model, where each iteration process includes the following steps: determining a depth estimation result of a sample image using the to-be-trained depth estimation model, determining a clarity estimation result of the sample image based on the depth estimation result using the to-be-trained clarity model, and based on the depth estimation result, the clarity estimation result, the depth label and the clarity label, determining a target loss value, where the target loss value is used to adjust parameters of the to-be-trained depth estimation model and the to-be-trained clarity model.

Optionally, the determination module 804 is specifically configured to: determine a first mean square error based on the depth estimation result and the depth label, determine a second mean square error based on the clarity estimation result and the clarity label, and sum the first mean square error and the second mean square error to obtain the target loss value.

Based on the same technical concept, an embodiment of the present disclosure provides a computer device, which may be a server, as shown in FIG. 9. The computer device includes at least one processor 901 and a memory 902 connected to the at least one processor. The embodiments of the present disclosure do not limit the specific connection medium between the processor 901 and the memory 902. FIG. 9 takes the example of a bus connection between the processor 901 and the memory 902. Buses may be categorized into address buses, data buses, control buses, etc.

In the embodiments of the present disclosure, the memory 902 stores instructions that may be executed by the at least one processor 901. The at least one processor 901 may perform the steps included in the above-described image processing methods by executing the instructions stored in the memory 902.

The processor 901 is the control center of the computer device. It may connect various parts of the computer device using various interfaces and lines, and perform image processing by running or executing instructions stored in the memory 902 and calling data stored in the memory 902. Optionally, the processor 901 may include one or more processing units. The processor 901 may integrate an application processor and a modem processor. The application processor mainly processes the operating system, user interface, and application programs, and the modem processor mainly processes wireless communications. It is to be noted that the above-described modem processor may not be integrated into the processor 901. In some embodiments, the processor 901 and the memory 902 may be implemented on a same chip. In some embodiments, the processor 901 and the memory 902 may also be implemented on separate chips.

The processor 901 may be a general-purpose processor, such as a central processing unit (CPU), a digital signal processor, an application-specific integrated circuit (ASIC), a field-programmable gate array or other programmable logic device, a discrete gate or transistor logic device, or a discrete hardware component, and may implement or execute the various methods, steps, and logic block diagrams disclosed in the embodiments the present disclosure. A general-purpose processor may be a microprocessor or any conventional processor. The steps of the methods disclosed in the embodiments of the present disclosure may be directly implemented as being executed by a hardware processor, or may be executed by a combination of hardware and software modules in the processor.

The memory 902, as a non-volatile computer-readable storage medium, may be used to store non-volatile software programs, non-volatile computer executable programs, and modules. The memory 902 may include at least one type of storage medium, such as flash memory, a hard disk, a multimedia card, a card-type memory, random access memory (RAM), static random access memory (SRAM), programmable read-only memory (PROM), read-only memory (ROM), electrically erasable programmable read-only memory (EEPROM), magnetic storage, a magnetic disk, an optical disk, and the like. The memory 902 may be any other medium capable of carrying or storing desired program code in the form of instructions or data structures and accessible by a computer, but is not limited thereto. In the embodiments of the present disclosure, the memory 902 may also be a circuit or any other device capable of performing a storage function, for storing program instructions and/or data.

Based on the same inventive concept, an embodiment of the present disclosure provides a computer-readable storage medium, which stores a computer program that may be executed by a computer device. When the program runs on the computer device, the computer device executes the steps of the above-described image processing methods.

Those skilled in the art will appreciate that the embodiments of the present disclosure may be provided as methods, systems, or computer program products. Therefore, the present disclosure may take the form of an entirely hardware embodiment, an entirely software embodiment, or an embodiment combining software and hardware. Furthermore, the present disclosure may take the form of a computer program product implemented on one or more computer-executable storage media (including but not limited to magnetic disk storage, CD-ROM, optical storage, etc.) containing computer-executable program code.

The present disclosure is described with reference to the flowcharts and/or block diagrams of the methods, devices (systems), and computer program products according to the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, a special-purpose computer, an embedded processor, or other programmable data processing apparatus to produce a machine, so that the instructions executed by the processor of the computer or other programmable data processing apparatus produce a device for implementing the functions specified in one or more processes in the flowcharts and/or one or more blocks in the block diagrams.

These computer program instructions may also be stored in a computer-readable memory that may direct a computer or other programmable data processing apparatus to operate in a specific manner, so that the instructions stored in the computer-readable memory produce a product including an instruction device that implements the functions specified in one or more processes in the flowcharts and/or one or more boxes in the block diagrams.

These computer program instructions may also be loaded onto a computer or other programmable data processing apparatus so that a series of operating steps are executed on the computer or other programmable device to produce a computer-implemented process, so that the instructions executed on the computer or other programmable device provide steps for implementing the functions specified in one or more processes in the flowcharts and/or one or more boxes in the block diagrams.

Apparently, those skilled in the art may make various changes and modifications to the present disclosure without departing from the spirit and scope of this present disclosure. Thus, if these modifications and variations of the present disclosure fall within the scope of the claims of the present disclosure and their equivalents, this present disclosure is intended to include these modifications and variations.

1. An image processing method, comprising:
obtaining a to-be-processed image;
predicting respective depth estimation values of a plurality of pixel points in the to-be-processed image using a depth estimation model;
predicting corresponding clarity estimation values, based on an obtained plurality of depth estimation values, using a clarity model;
determining forged points among the plurality of pixel points based on an obtained plurality of clarity estimation values and respective actual clarity values of the plurality of pixel points; and
if a quantity of the forged points is greater than a first threshold, determining the to-be-processed image to be a forged image.

2. The method according to claim 1, wherein determining the forged points among the plurality of pixel points based on the obtained plurality of clarity estimation values and the actual clarity values of the plurality of pixel points comprises:
for the plurality of pixel points, performing the following steps respectively:
if a difference between a clarity estimation value of a pixel point and an actual clarity value of the pixel point is greater than a second threshold, determining the pixel point to be a forged point.

3. The method according to claim 1, further comprising:
for the plurality of pixel points, performing the following steps respectively:
determining multiple neighboring pixel points of a pixel point, as well as a grayscale difference and a distance value between the pixel point and each of the neighboring pixel points, and determining a grayscale change rate between the pixel point and each of the neighboring pixel points based on the obtained grayscale difference and distance value; and
summing obtained multiple grayscale change rates, to obtain an actual clarity value of the pixel point.

4. The method according to claim 1, wherein the clarity model includes a first convolutional layer, a nonlinear mapping layer, and a second convolutional layer, and predicting the corresponding clarity estimation values based on the obtained plurality of depth estimation values through the clarity model comprises:
for each depth estimation value, performing a convolution processing on the depth estimation value through the first convolution layer to obtain intermediate features;
mapping the intermediate features through the nonlinear mapping layer to determine a feature mapping result; and
performing a convolution processing on the feature mapping result by the second convolutional layer to obtain a corresponding clarity estimation value.

5. The method according to claim 1, wherein the depth estimation model and the clarity model are obtained by joint training.

6. The method according to claim 5, wherein the depth estimation model and the clarity model are jointly trained by:
obtaining a plurality of sample images, each sample image corresponding to a depth label and a clarity label; and
jointly and iteratively training a to-be-trained depth estimation model and a to-be-trained clarity model using the plurality of sample images until an iteration stop condition is satisfied, and outputting a trained depth estimation model and a trained clarity model,
wherein each iteration process includes the following steps:
determining a depth estimation result of a sample image using the to-be-trained depth estimation model, and determining a clarity estimation result of the sample image based on the depth estimation result using the to-be-trained clarity model, and
determining a target loss value based on the depth estimation result, the clarity estimation result, the depth label and the clarity label, and adjusting parameters of the to-be-trained depth estimation model and the to-be-trained clarity model using the target loss value.

7. The method according to claim 6, wherein determining the target loss value based on the depth estimation result, the clarity estimation result, the depth label, and the clarity label comprises:
determining a first mean square error based on the depth estimation result and the depth label;
determining a second mean square error based on the clarity estimation result and the clarity label; and
summing the first mean square error and the second mean square error to obtain the target loss value.

8. (canceled)

9. A computer device, comprising a memory, a processor, and a computer program stored in the memory and executable on the processor, wherein when executing the program, the processor is configured to perform:
obtaining a to-be-processed image;
predicting respective depth estimation values of a plurality of pixel points in the to-be-processed image using a depth estimation model;
predicting corresponding clarity estimation values, based on an obtained plurality of depth estimation values, using a clarity model;
determining forged points among the plurality of pixel points based on an obtained plurality of clarity estimation values and respective actual clarity values of the plurality of pixel points; and
if a quantity of the forged points is greater than a first threshold, determining the to-be-processed image to be a forged image.

10. A computer-readable storage medium storing a computer program executable by a computer device, wherein when the program is run on the computer device, the computer device is configured to perform:
obtaining a to-be-processed image;
predicting respective depth estimation values of a plurality of pixel points in the to-be-processed image using a depth estimation model;
predicting corresponding clarity estimation values, based on an obtained plurality of depth estimation values, using a clarity model;
determining forged points among the plurality of pixel points based on an obtained plurality of clarity estimation values and respective actual clarity values of the plurality of pixel points; and
if a quantity of the forged points is greater than a first threshold, determining the to-be-processed image to be a forged image.

11. A computer program product, storing a computer program, wherein the computer program includes program instructions, and when the program instructions are executed by a computer, the computer is caused to perform the steps of the method according to claim 1.

12. The computer device according to claim 9, wherein the processor is further configured to perform:
for the plurality of pixel points, performing the following steps respectively:
if a difference between a clarity estimation value of a pixel point and an actual clarity value of the pixel point is greater than a second threshold, determining the pixel point to be a forged point.

13. The computer device according to claim 9, wherein the processor is further configured to perform:
for the plurality of pixel points, performing the following steps respectively:
determining multiple neighboring pixel points of a pixel point, as well as a grayscale difference and a distance value between the pixel point and each of the neighboring pixel points, and determining a grayscale change rate between the pixel point and each of the neighboring pixel points based on the obtained grayscale difference and distance value; and
summing obtained multiple grayscale change rates, to obtain an actual clarity value of the pixel point.

14. The computer device according to claim 9, wherein the clarity model includes a first convolutional layer, a nonlinear mapping layer, and a second convolutional layer, and the processor is further configured to perform:
for each depth estimation value, performing a convolution processing on the depth estimation value through the first convolution layer to obtain intermediate features;
mapping the intermediate features through the nonlinear mapping layer to determine a feature mapping result; and
performing a convolution processing on the feature mapping result by the second convolutional layer to obtain a corresponding clarity estimation value.

15. The computer device according to claim 9, wherein the depth estimation model and the clarity model are obtained by joint training.

16. The computer device according to claim 15, wherein the depth estimation model and the clarity model are jointly trained by:
obtaining a plurality of sample images, each sample image corresponding to a depth label and a clarity label; and
jointly and iteratively training a to-be-trained depth estimation model and a to-be-trained clarity model using the plurality of sample images until an iteration stop condition is satisfied, and outputting a trained depth estimation model and a trained clarity model,
wherein each iteration process includes the following steps:
determining a depth estimation result of a sample image using the to-be-trained depth estimation model, and determining a clarity estimation result of the sample image based on the depth estimation result using the to-be-trained clarity model, and
determining a target loss value based on the depth estimation result, the clarity estimation result, the depth label and the clarity label, and adjusting parameters of the to-be-trained depth estimation model and the to-be-trained clarity model using the target loss value.

17. The computer device according to claim 16, wherein the processor is further configured to perform:
determining a first mean square error based on the depth estimation result and the depth label;
determining a second mean square error based on the clarity estimation result and the clarity label; and
summing the first mean square error and the second mean square error to obtain the target loss value.
